(19) United States
(12) Patent Application Publication
(10) Pub. No.: US 2025/0059065 A1
(43) Pub. Date: Feb. 20, 2025

(54) SYSTEM AND METHOD FOR REMOTELY MONITORING WATER QUALITY

(71) Applicant: Max Finselbach, Queensland (AU)

(72) Inventor: Max FINSELBACH, Yaroomba (AU)

(21) Appl. No.: 18/721,957

(22) PCT Filed: Dec. 23, 2022
(86) PCT No.: PCT/AU2022/051585

§ 371 Date: Jun. 20, 2024

(30) Foreign Application Priority Data
Dec. 23, 2021 (AU) 2021904244

(51) Int. Cl. C02F 1/00; G06Q 10/0639

(52) U.S. Cl. CPC C02F 1/008; G06Q 10/06395; C02F 2201/009; C02F 2209/001; C02F 2209/006; C02F 2209/008; C02F 2209/05; C02F 2209/06; C02F 2209/36; C02F 2209/44

(57) ABSTRACT

The present invention relates to a computer-implemented method for remotely monitoring the quality of a contained volume of water, the method including, receiving, by one or more processors, data from one or more sensor devices or modules operable to monitor one or more attributes of water quality associated with the contained volume of water, receiving, by one or more processors, data from one or more third party services that provide forecast data relating to environmental conditions at a geographical region in which the contained volume of water is located, the environmental conditions of a type that have an effect upon the one or more water quality attributes, generating, by one or more processors, based upon the data from the one or more sensor devices or modules, and the forecast data received from the one or more third party services, a prediction regarding how the one or more attributes of water quality are likely to change over a period of time, and processing, by one or more processors, the data from the one or more sensor devices or modules, the forecast data received from the one or more third party services, and the generated prediction, to generate a graphical user interface (GUI) including one or more user interface objects adapted to be displayed on a data communication device associated with a user, wherein the one or more attributes of water quality, and the prediction relating to how the one or more attributes of water quality are likely to change over a period of time are overlaid on the one or more user interface objects, thereby assisting the user to identify, substantially in real-time, an indication regarding the one or more attributes of water quality and the prediction regarding variation of same into the future.

### FIELD OF THE INVENTION

The present invention relates to a system and method for remotely monitoring one or more water quality attributes associated with a contained volume of water and generates a graphical user interface (GUI) on a computing device for display to a remotely located user, the GUI indicating a water quality attribute as well as a prediction regarding how the attribute is likely to change over a period of time according to forecast data.

### BACKGROUND OF THE INVENTION

Water is essential for day-to-day life and whilst there are natural sources of water (e.g. rivers, streams, etc) that can be accessed for the purpose of consumption, irrigation, etc, most properties will not have direct access to a natural water source and at most locations it is necessary to contain water (or transport water to the property) for storage of same. For example, most residential and rural properties in Australia utilise rain-water tanks to collect rainfall captured at the properties with such water typically utilised to provide drinking water for pets and farm animals, and to provide irrigation for gardens, and farm crops. Water tanks that are not dependent upon rainfall (or at least not solely dependent) are also common, and these types of tanks may be re-filled by transporting water to the location for the specific purpose of re-filing such tanks.

Irrespective of how water is sourced (i.e. from rain or by transportation) or contained (i.e. in a river bank, reservoir or tank), there is a common requirement for the quality of the contained volume of water to be monitored. For example, it is important for the quality of water to be monitored to ensure it is suitable for its designated consumption, e.g. drinking, irrigation, etc. Where a rural property is reliant upon the health of animals and crops for the purpose of generating an income, contaminated water supplies may also translate into reduced income.

A problem with monitoring the quality of a contained volume of water is that traditional monitoring techniques require users to be physically present at the location of the contained water and hence such monitoring is unable to occur when the user is located remotely, or is not able to access the location for any reason. Whilst this is not a significant problem in residential settings where, for example, the water quality in a tank can easily be monitored by human observation, this can be a significant problem in rural settings where multiple tanks are often geographically dispersed across a farm property and individual tanks may be separated by kilometres, making monitoring by observation difficult and time consuming. The requirement for human monitoring also places a significant restriction on the movements of a farmer since there needs to be at least one person on site at all times to ensure that regular monitoring is performed. There may also be situations where a farmer will simply forget to check the quality of water stored in their tanks.

The use of sensors and measuring devices in water tanks to measure the quality of contained water, and to transmit data to enable remote monitoring of the water quality, is known. Irrespective of whether water quality is measured by human observation, or by more sophisticated means (using sensors and measuring devices), the result of such monitoring relates to an instance in time and hence fails to provide the user with an indication regarding how the particular measured quality is likely to change over time (i.e. into the future). There are various factors that affect water quality inside tanks, including weather conditions to which water in the tank may be exposed (e.g. wind, rain, and heat), along with other factors such as the material used in the tank or tank lining, etc. In respect of contained volumes of water such as rivers and dams, factors that affect the quality of water include soil type (the propensity for acid and other contaminants to be released from the soil), naturally occurring blackwater events which cause organic matter to be washed into waterways depleting dissolved oxygen in the water, bushfires which result in sediments and pollutants that run into waterways, naturally occurring salinity, runoff from urban areas resulting in high levels of nutrients, sediments and heavy metals in the water, and the generation of bacteria such as algae which is particularly prevalent in still or slow flowing water.

There are various ways to prevent contamination of water, including the use of mesh screens and filters, as well as treating contaminated water including the use of chemicals such as chlorine to disinfect water, and ultraviolet (UV) light irradiation. It would be beneficial for at least farmers to have the ability to check the quality of water in their tanks from a remote location at any time, and to also understand how water quality is likely to behave into the future over the coming days, weeks and months. Such knowledge would allow farmers greater flexibility and importantly freedom to leave their property with increased certainty that their tanks are unlikely to become contaminated to an extent likely to have an adverse impact upon their property and livelihood.

Similar principles apply to natural sources of water. Whilst Government agencies may regularly monitor the quality of water in rivers, dams and the like, there is a need to be able to accurately predict changes to water quality without the requirement to send personnel to the relevant locations for regular monitoring.

The currently available technologies known to the Applicant for the purpose of monitoring and managing the quality of a contained volume of water utilise significant amounts of computer processing, memory and network resources. Accordingly, a technical problem exists regarding how such resources may be utilised more efficiently and conserved without compromising the quality of the ongoing monitoring and management task.

The computer-implemented system and method of the present invention seeks to address the above identified problems or at least provide an alternative solution to same.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method for remotely monitoring the quality of a contained volume of water, the method including, receiving, by one or more processors, data from one or more sensor devices or modules operable to monitor one or more attributes of water quality associated with the contained volume of water, receiving, by one or more processors, data from one or more third party services that provide forecast data relating to environmental conditions at a geographical region in which the contained volume of water is located, the environmental conditions of a type that have an effect upon the one or more water quality attributes, generating, by one or more processors, based upon the data from the one or more sensor devices or modules, and the forecast data received from the one or more third party services, a prediction regarding how the one or more attributes of water quality are likely to change over a period of time, and processing, by one or more processors, the data from the one or more sensor devices or modules, the forecast data received from the one or more third party services, and the generated prediction, to generate a graphical user interface (GUI) including one or more user interface objects adapted to be displayed on a data communication device associated with a user, wherein the one or more attributes of water quality, and the prediction relating to how the one or more attributes of water quality are likely to change over a period of time are overlaid on the one or more user interface objects, thereby assisting the user to identify, substantially in real-time, an indication regarding the one or more attributes of water quality and the prediction regarding variation of same into the future.

In an embodiment, the contained volume of water is associated with one or more of a tank, a trap, a river, a dam, or a reservoir.

In an embodiment, the one or more third party services provides forecast data relating to environmental conditions at the geographical region in which the contained volume of water is located.

In an embodiment, the one or more third party services that provide forecast data includes a third party service capable of providing weather forecasting data, wherein the weather forecasting data relates to future environment conditions including forecasted temperature, wind and/or rain in the geographical region (e.g. Amazon forecast application programming interface (API), access to data systems associated with a Bureau of Meteorology (BOM), etc).

In an embodiment, the method further includes providing data obtained from the one or more sensor devices or modules to the one or more third party services.

In an embodiment, the data from the one or more sensor devices or modules operable to monitor one or more attributes of water quality includes data captured in substantially real-time, in addition to historical data previously captured from the one or more sensor devices or modules. By utilising historical data, trends in the data may be determined which may be used (e.g. in isolation, or in combination with the forecast data) when determining the prediction regarding how the one or more attributes of water quality are expected to change over a period of time.

In an embodiment, the one or more sensor devices or modules includes Internet of Things (IOT) devices appropriately positioned in, or adjacent, the contained water to capture data relating to the one or more attributes of water quality. For example, in the case of a water tank, one or more sensor devices may be affixed to an internal wall of the tank in order to measure water quality attributes.

In an embodiment, each sensor device or module has a battery source operable to be charged by solar power.

In an embodiment, the one or more processors are associated with a central server and the one or more sensor devices or modules are configured to wirelessly transmit captured data directly to a central server, or indirectly to the central server via one or more intermediate devices.

In an embodiment, the intermediate devices are configured to receive and transmit data, or at least extend or enhance a signal transmitted by the one or more sensor devices or modules. For example, an intermediate device may be in the form of a modem, a terrestrial transponder, or a satellite transponder, and the intermediate device may be mounted to an autonomous vehicle capable of travelling between a first location adjacent the one or more sensor devices or modules and a second location adjacent the central server.

In an embodiment, the forecast data relates to future environmental conditions including forecasted temperature, wind, fire (bushfire), UV and rain (precipitation) in the geographical region, as well as data relating to how such environmental conditions are likely to change over a period of time (e.g. over the course of a day, night, 24 hour period, week, month, etc).

In one example, where a significant downpour is forecast and there is a chance of flooding (an example of a blackwater event), then such an event may be identified as likely to give rise to increased organic matter in waterways which can have the effect of increasing dissolved carbon in the water. Accordingly, by capturing forecast data, it can be predicted that an attribute of water quality (i.e. carbon content in the water) is likely to increase in the future. Similarly, if the forecast data indicates that a particular waterway is likely to be affected by a nearby bushfire, i.e. increased risk of sediments and pollutants, then again it can be predicted that an attribute of water quality (i.e. level of sediment and pollutants) will be affected.

In an example involving a water tank holding still water, levels of bacteria in the tank (e.g. algae) may increase when there is an abundance of sunlight for example. Accordingly, if the forecast data indicates multiple days or weeks of sunlight, then it can be predicted that an attribute of water quality (e.g. level of bacteria) will be affected. Similarly, if rain is forecast, this may have a positive effect upon the quality of water stored in the tank since the additional rain may serve to dilute the quantity of contaminants.

In an embodiment, the one or more user interface objects includes one or more of, a digital display of the real-time indication of the one or more attributes of water quality (e.g. real-time values associated with each detected attribute), a digital display of the real-time indication of the one or more attributes of water quality as compared with a predefined value for the one or more attributes (e.g. the level of pollutants as compared with a predefined safety threshold for such pollutants), a digital display of one or more current and/or future environmental conditions in the geographical region (e.g. a current and/or future UV or precipitation forecast), a digital display of a period of time (e.g. day, week, month) and an estimation regarding how the one or more attributes of water quality are likely to change over the period of time; and a digital display of one or more graphs of which one axis represents time, and another axis relates to the one or more attributes of water quality (e.g. a graph of pollutant level, algae level, acidity, salinity, etc, versus time).

In an embodiment, the period of time displayed in the GUI may be selected by a user (e.g. the user may select to view how the water quality in a particular tank is likely to change over the next 24 hours, the next 2 days, over the next 7 days, or over the next month, etc).

In an embodiment, the one or more attributes of water quality may be displayed in a two-dimensional or three-dimensional graphical representation that represents the actual appearance of the one or more attributes of water quality (e.g. a 2-D or 3-D graphical image of a tank or waterway with a graphical indication of different attributes of water quality, such as a level of contaminants, pollutants, sediment, salinity, etc, detected in the actual tank or waterway at the particular point in time).

In an embodiment, the method further includes causing one or more actions to be performed when the one or more attributes of water quality are detected as failing to satisfy a predefined requirement or threshold, wherein the one or more actions include one or more of, generating a notification or alert (e.g. where a value exceeds a maximum threshold, or is below a minimum threshold), and operating one or more devices associated with the contained volume of water, the one or more devices configured to improve the one or more attributes of water quality.

In an embodiment, the notification or alert is transmitted to the user by one or more of overlaying the notification or alert on a graphical user interface object displayed to the user in the GUI, or alternatively and/or additionally, a push notification, text message or email to a user device.

In an embodiment, the contained volume of water is associated with a tank, and the one or more devices include a pump associated with the tank, the pump configured to automatically provide additional water to the tank when a quantity of contaminants in the water are detected as exceeding, or are predicted to exceed, a predefined safety threshold. By pumping water into the tank, the contaminants present in the water may be diluted and returned to a quantity that satisfies the safety threshold or may avoid an otherwise predicted safety risk regarding contaminant concentration.

In another embodiment, the contained volume of water resides within a pipeline. In this regard, the water may be still or flowing but in either instance, the water is contained within the structure defining the pipe. As will be appreciated by skilled readers, the volume of water contained within a pipeline can be significant particularly where the pipeline extends for a long length (e.g., many kilometres) and represents a storage/supply of water available to a geographical region.

In an embodiment, the method further includes receiving, by one or more processors, user feedback data regarding the success or otherwise of different strategies with respect to managing water quality associated with the contained volume of water (e.g. whether a particular type of tank or tank liner gives rise to decreased contamination and lasts longer than another type of tank/liner, whether causing a tank to be exposed to sunlight or covered results in additional water quality benefits, whether causing a tank to be re-filled at a particular time of year or to be located in a particular geographical region results in additional water quality benefits as compared with other times of year/regions, whether using one water treatment method (e.g. filtration, chlorination, UV, etc) as compared with other methods results in additional water quality benefits, etc).

In an embodiment, the method further includes storing, in one or more databases, data captured by the one or more sensor devices or modules, the forecast data, and any feedback data, thereby enabling development of a database of useful data for subsequent analysis and/or training a machine learning model.

In an embodiment, the method further includes generating, using the trained machine learning model, recommendations regarding future water quality management strategies with respect to the contained volume of water, the machine learning model trained over time using the stored data including feedback data relating to the success or otherwise associated with different management strategies.

In a second aspect, the present invention provides a system for remotely monitoring a contained volume of water, the system including one or more processors operable to receive data from one or more sensor devices or modules operable to monitor one or more attributes of water quality associated with the contained volume of water, receive data from one or more third party services that provide forecast data relating to environmental conditions at a geographical region in which the contained volume of water is located, the environmental conditions of a type that have an effect upon the one or more water quality attributes, generate, based upon the data from the one or more sensor devices or modules, and the forecast data received from the one or more third party services, a prediction regarding how the one or more attributes of water quality are likely to change over a period of time, and process the data from the one or more sensor devices or modules, the forecast data received from the one or more third party services, and the generated prediction, to generate a graphical user interface (GUI) including one or more user interface objects adapted to be displayed on a data communication device associated with a user, wherein the one or more attributes of water quality, and the prediction relating to how the one or more attributes of water quality are likely to change over a period of time are overlaid on the one or more user interface objects, thereby assisting the user to identify, substantially in real-time, an indication regarding the one or more attributes of water quality and the prediction regarding variation of same into the future.

In a third aspect, the present invention provides a computer-readable medium having a plurality of instructions executable by one or more processors to receive data from one or more sensor devices or modules operable to monitor one or more attributes of water quality associated with the contained volume of water, receive data from one or more third party services that provide forecast data relating to environmental conditions at a geographical region in which the contained volume of water is located, the environmental conditions of a type that have an effect upon the one or more water quality attributes, generate, based upon the data from the one or more sensor devices or modules, and the forecast data received from the one or more third party services, a prediction regarding how the one or more attributes of water quality are likely to change over a period of time, and process the data from the one or more sensor devices or modules, the forecast data received from the one or more third party services, and the generated prediction, to generate a graphical user interface (GUI) including one or more user interface objects adapted to be displayed on a data communication device associated with a user, wherein the one or more attributes of water quality, and the prediction relating to how the one or more attributes of water quality are likely to change over a period of time are overlaid on the one or more user interface objects, thereby assisting the user to identify, substantially in real-time, an indication regarding the one or more attributes of water quality and the prediction regarding variation of same into the future.

### BRIEF DESCRIPTION OF THE DRAWINGS

Features of the present disclosure are illustrated by way of example and not limited in the following Figure(s), in which like numerals indicate like elements, in which:

FIG. 1 provides an overview of a system according to an embodiment of the present invention showing, in particular, the interaction of various system components;

FIG. 2 illustrates an exemplary diagram associated with the server component within the system illustrated in FIG. 1;

FIG. 3 illustrates an exemplary flow diagram of the server component of FIG. 2 including an internet gateway device configured to communicate with one or more water quality sensors associated with a volume of water contained inside a tank;

FIG. 4 illustrates an exemplary flow diagram of the server component of FIG. 2 communicating with one or more intermediary devices used to extend or enhance the signal transmitted by the one or more sensor devices shown in FIG. 3;

FIG. 5 illustrates an exemplary flow diagram of a process that enables a user to download and install a software application, and subsequently access, or registered to use, the software application for interaction with the system illustrated in FIG. 1;

FIG. 6 illustrates an exemplary flow diagram of a process that enables the user to utilise the software application to view one or more attributes of water quality associated with the contained volume of water, and a prediction relating to how the one or more attributes of water quality are likely to change over a period of time; and

FIG. 7 illustrates an exemplary flow diagram of the server component of FIG. 2 communicating with one or more third party services for the purpose of collecting forecast data relating to environmental conditions at the geographical region in which the contained volume of water is located and which may have an effect upon the one or more attributes of water quality.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth in order to provide a thorough understanding of the disclosure. It will be readily apparent, however, that the current disclosure may be practised without limitation to the specific details disclosed herein. In other instances, some methods and structures have not been described in detail to avoid obscuring the disclosure.

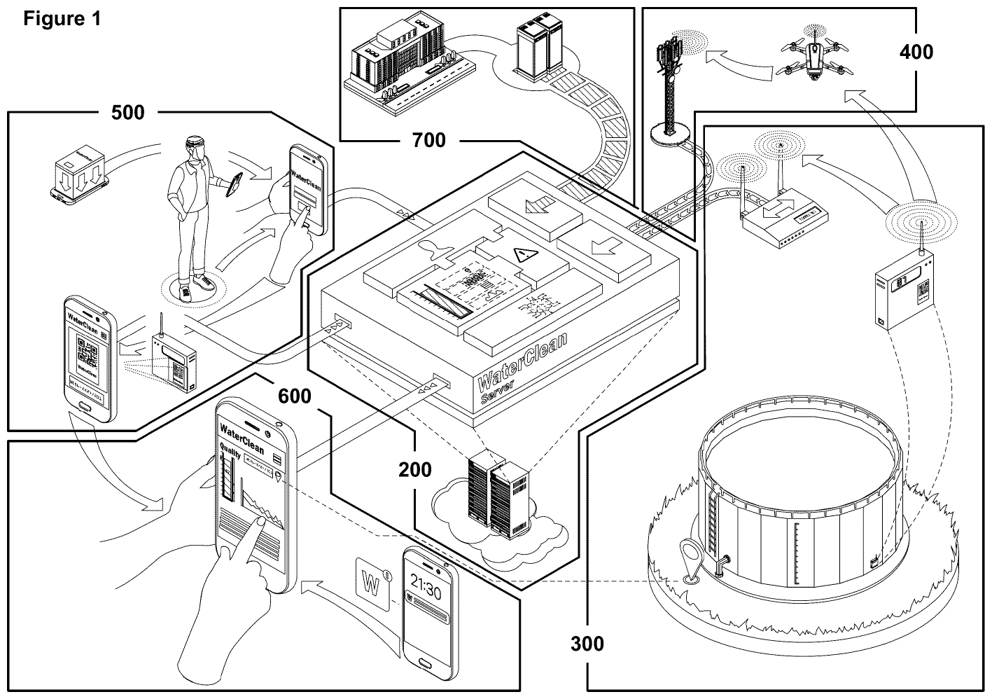

In an embodiment, the present invention provides a system and method for remotely monitoring a contained volume of water and, in particular, one or more attributes of water quality associated with the contained volume of water, with the major system components depicted in FIG. 1. In the embodiment shown in the accompanying Figures, the contained body of water is a tank (60). However, it is to be understood that the contained volume of water may be in the form of any other type of enclosure or partial enclosure including a trap, river, dam, reservoir, pipeline or storage vessel that contains a quantity of water. The embodiment of the system and method described provides a platform that hosts a computer-executable software application (40), wherein the application (40) is accessible by a plurality of users (30) who prefer to monitor water quality attributes associated with contained volumes of water (e.g. one or more tanks on a farm owned by the user (30)). The platform enables the generation of a display (340) of one or more water quality attributes (e.g. pollutant level, sediment level, bacteria level, salinity, acidity, etc) of the contained body of water, and a prediction regarding how the one or more attributes of water quality are likely to change over a period of time (e.g. a forecast), thereby assisting the user (30) to obtain, substantially in real-time, an indication of the one or more water quality attributes and the prediction regarding variation of same into the future.

The central server (20) maintains one or more processors and/or databases for performing functions, including receiving (170) data from one or more sensor devices or modules (70) operable to monitor one or more water quality attributes associated with the contained volume of water (60), and receiving (180) data from one or more third party services (80) that provide forecasted data relating to environmental conditions of a geographical region in which the contained volume of water (60) is located (74) and the environmental conditions of a type that have an effect on the one or more water quality attributes.

Based upon the data from the one or more sensor devices or modules (70) and forecast data received from the one or more third party services (80), the server (20) may then generate a prediction regarding how the one or more water quality attributes are likely to change over a period of time, and further generate a graphical user interface (340) including one or more user interface objects (e.g. tables, graphs, etc.) adapted to be displayed on a device (50) associated with the user (30). In this regard, the one or more water quality attributes of the contained volume of water (60) and the prediction regarding how the attributes are likely to change over a period of time may be overlaid on the one or more user interface objects, thereby assisting the user (30) to identify the one or more water quality attributes and the prediction at any moment in time.

The skilled reader will appreciate that the platform provides a solution that allows for the simplified monitoring and analysis of quality attributes associated with a contained volume of water (60) through a mobile application (40) operating on a user device (50). The application (40) displays the real-time, or near real-time, water quality attributes (e.g. pollutant level, sediment level, bacteria level, salinity, acidity, etc) and provides intelligent predictive analysis to alert the user (30) to situations where such water quality attributes are reaching particular thresholds, or are likely to reach particular thresholds, in the future (e.g. where the quantity of a particular contaminant is reaching, or is likely to reach, an unsafe level based upon a predefined safety threshold). The solution may also provide recommendations to address water quality issues, or predicted forthcoming issues, and/or may automatically cause one or more actions to occur (e.g. cause an external device such as a water pump to operate, or to release a chemical treatment into the volume of water) to address the water quality issue or predicted forthcoming issue. Such actions may also be scheduled for an appropriate future time depending upon the prediction that is generated in relation to the water quality at that future time.

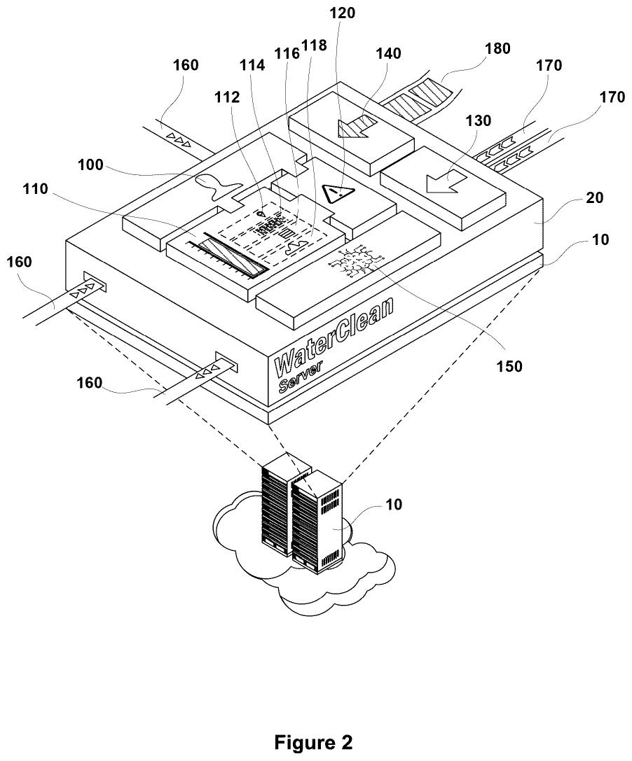

FIG. 1 is divided into segments which are further expanded in subsequent FIGS. 2 to 7. In particular, Segment 200 of FIG. 1 depicts the server component (20) in respect of which the software application (40) operating on data communication devices (50) of users (30) are configured to communicate. It will be apparent to the skilled reader that the software application (40) may be a mobile application or a web application, and similarly, the data communication device (50) associated with each user (30) may be a mobile device or a fixed location computing device. Examples of mobile devices include mobile phones or computer tablets, and examples of fixed location computing devices include workstations or personal computers.

The server component is further detailed in FIG. 2 and the skilled reader will appreciate that the steps described herein, as executable by the devices (50), may be facilitated by the software application (40) operating on each device (50).

As an alternative, or in addition to, steps described herein as performed by the server (20), the steps described may be performed by one or more processors associated with the user devices (50) (i.e. in a distributed architecture). Different arrangements are possible in this regard, but according to a particular implementation of the present invention, the server (20) is programmed to provide all of the functions provided herein where they cannot be provided locally on the user devices (50), or where it may be impractical to do so.

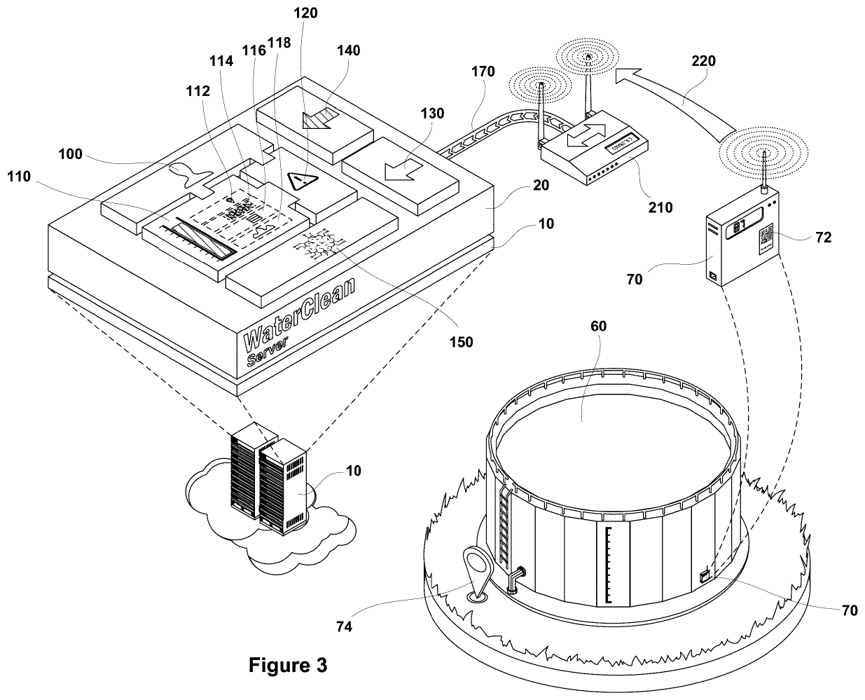

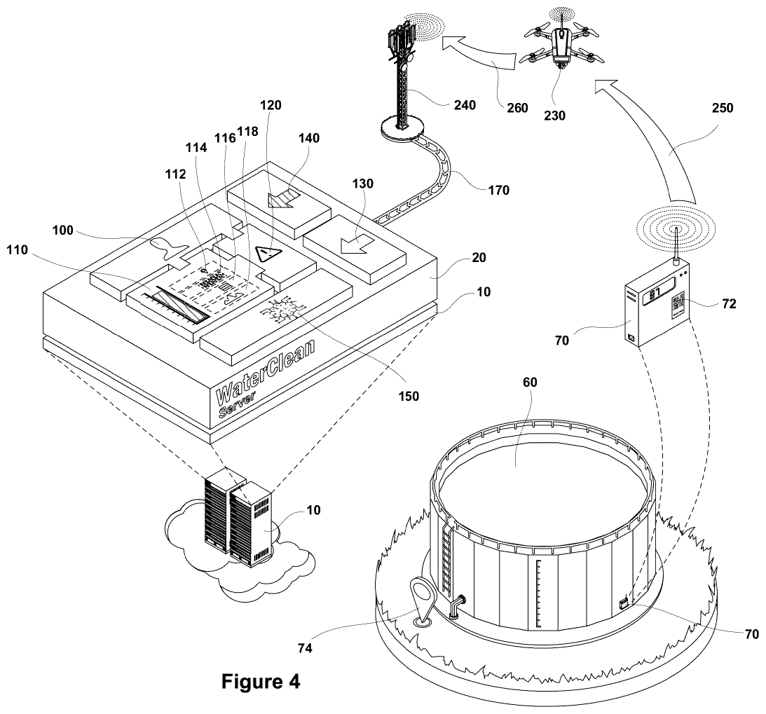

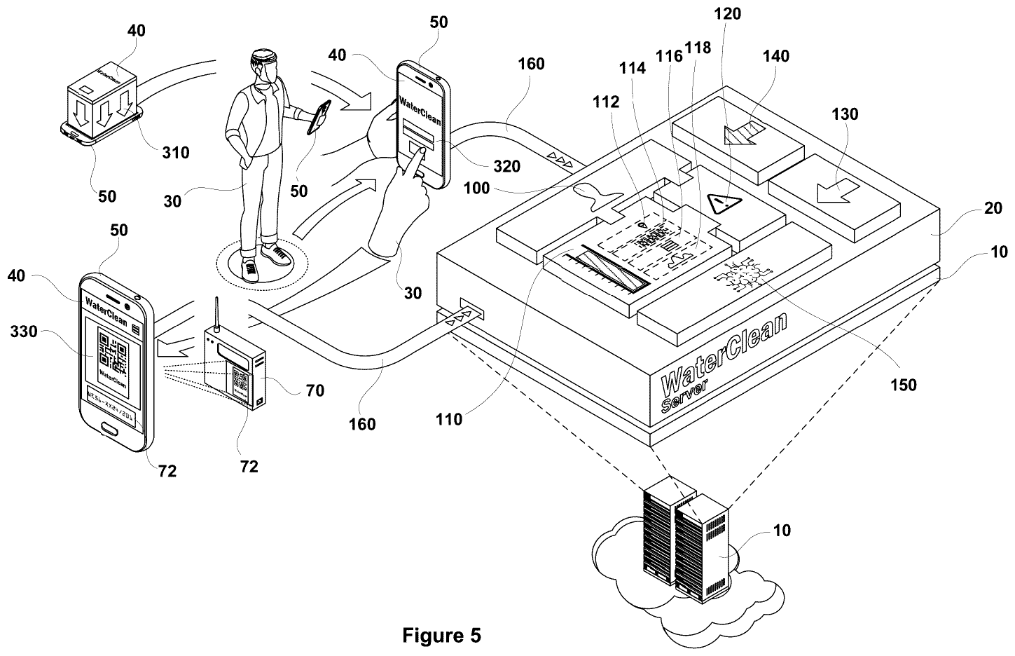

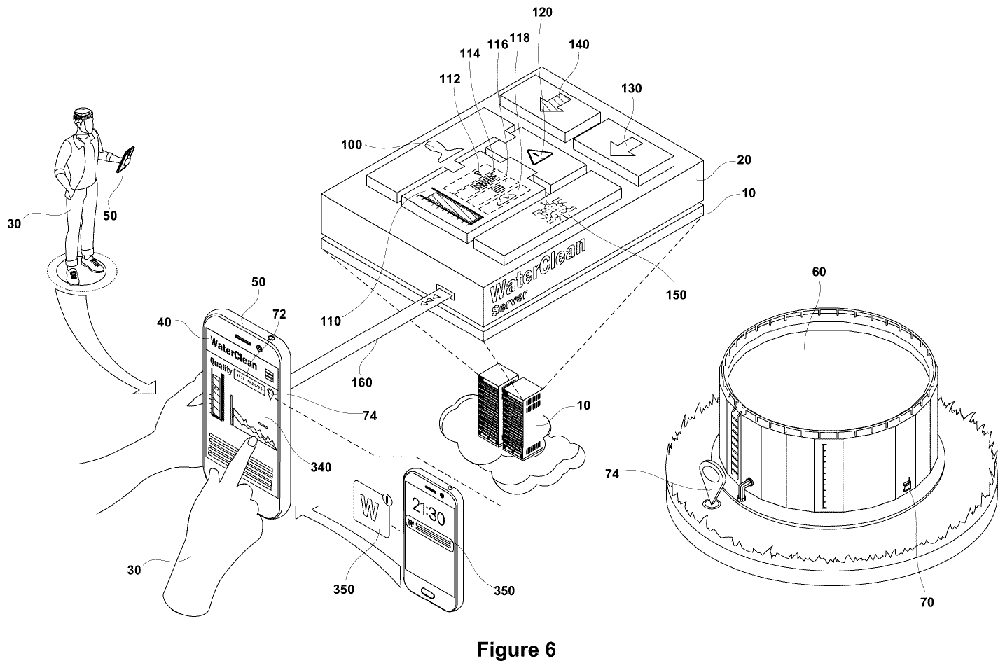

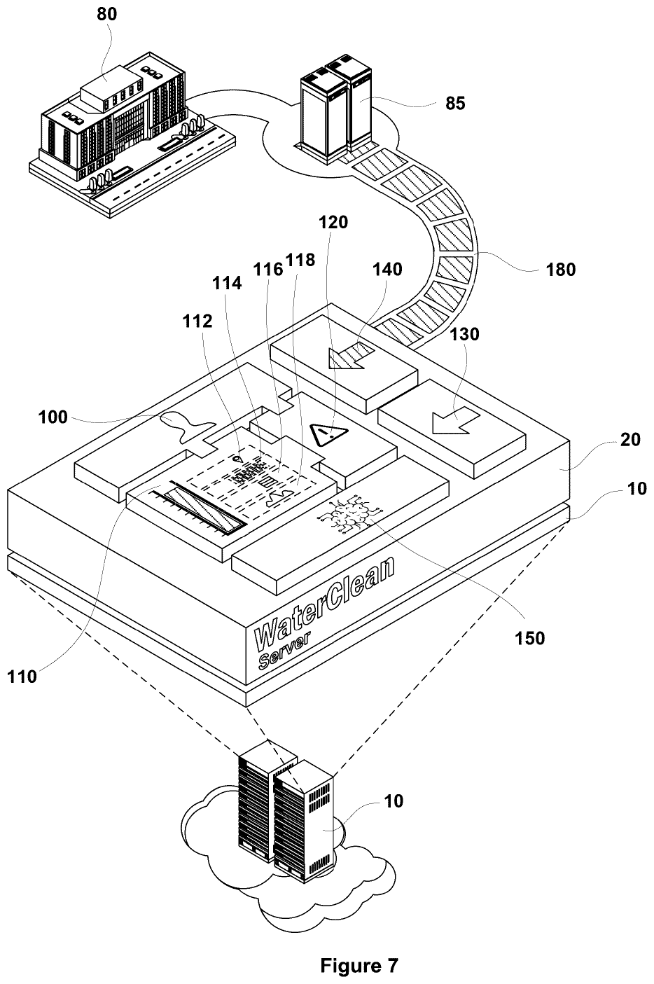

Segment 300 of FIG. 1 depicts an example of how the server (20) may be configured for communication (170) with the one or more sensor devices or modules (70) associated with the contained volume of water (60), which is further detailed in FIG. 3. Segment 400 of FIG. 1 depicts how the server (20) may also be configured for communication (180) with one or more intermediary devices (230, 240) which may be used to extend or enhance the signal transmitted by the one or more sensor devices or modules (70), as further detailed in FIG. 4. Segment 500 of FIG. 1 shows a user (30) downloading and installing the software application (40) and subsequently registering the one or more sensors or modules (70) to associate the sensors or modules (70) with an account established for the user, as further detailed in FIG. 5. Segment 600 of FIG. 1 illustrates how the user (30) may utilise the application (40) to view the one or more quality attributes of the contained volume of water (60) in addition to a prediction regarding how the one or more water quality attributes are likely to change over a period of time, as further detailed in FIG. 6. Finally, Segment 700 of FIG. 1 illustrates how the server (20) may be configured for communication (180) with the one or more third party services (80) for retrieving forecast data, as detailed in FIG. 7.

As mentioned above, FIG. 2 shows in greater detail the Segment (200) of FIG. 1, and in particular, FIG. 2 depicts the server component (20) which includes infrastructure (10) upon which the platform of the present invention may operate. The infrastructure may be local or cloud-based. The central server (20) may operate one or more computer processors and maintain one or more databases to enable the following functionality and/or storage:
User account register (100) storing details of users (30) who are registered to use the software application (40) (e.g. name, address, contact details, and any additional data which may be relevant for the purpose of identifying each user). Where possible, these details may be verified using identification verification services;
Sensor or module register (110) storing details relating to each sensor device or module (70) registered with the application (40) by users (30), e.g. salinity measurement sensors, acidity measurement sensors, bacteria measurement sensors, etc. The register (110) may further store unique identification details (72) associated with each sensor device or module (70), (e.g. unique sensor serial number or code that identifies a particular sensor, which may be printed on the sensor as a number or as a QR code for easy capture and entry), and the identification details may be linked to particular user accounts stored in register (100);
Sensor location and historical data (112) storing data relating to the geographical location (74) of each registered sensor device or module (70), as well as historical water quality attribute data (114) relating to the one or more water quality attributes that have been captured by the one or more sensor devices or modules (70) over time;
Sensor attribute data (116) storing data relating to the one or more water quality attributes that have been captured by the one or more sensor devices or modules (70) (e.g. historical data relating to the water level in the contained volume of water (60) as captured by the sensor device(s) (70);
Current attribute data (116) storing real-time or near real-time data relating to one or more attributes captured by the sensor devices or modules (70) (e.g. the current level of contamination of water stored in the storage tank (60));
Prediction data (118) storing data relating to predictions generated by the server (20) in relation to how the one or more water quality attributes are likely to change over a period of time in the future;
Threshold data (120) storing details relating to certain thresholds which give rise to alerts or notifications to be generated and provided to users (30) (e.g. thresholds relating to notifiable events including when the water contamination level is detected as being above a threshold level, or where the prediction data (118) indicates that a water contamination level is likely to be above a threshold within a predetermined period of time into the future;
Sensor data collection (130) including functionality that receives and validates data from the one or more sensor devices or modules (70), and subsequently, based upon an acceptable validation, stores same in database (114) and/or (116);
Forecast data collection (140) including functionality that enables the server (20) to receive and collect forecast data from the one or more third party services (80) which, as shown in FIG. 7, may include data systems (85) used by the providers (80) to store data such as weather and other forecasts (e.g. river levels and other environmental observations captured by a bureau of meteorology);
Predictive analysis functionality (150) which enables the processing of the data from the one or more sensor devices or modules (70) (current and/or historical) together with the forecast data (118) received from the one or more third party services (80) in order to generate the graphical user interface (340) which indicates a current status of the one or more water quality attributes as well as a forecast with respect to the one or more water quality attributes (i.e. how the one or more attributes is likely to change over a period of time). Additional data may be processed by the intelligent predictive analysis functionality (150), namely, data received in addition to the data from the sensors and the forecast data (e.g. data relating to the storage location (74), historical usage data, and various other data inputs as may be appropriate for the purpose of generating a more accurate prediction), thereby assisting the user (30) in their water quality management.

FIG. 2 also depicts that server (20) is configured to enable communication (160) with the devices (50) and, in particular, the software application (40) operating on each device (50). FIGS. 2 to 4 also show how server (20) is configured to communicate (170) with the one or more sensor devices or modules (70), and/or the intermediate devices (230, 240). FIGS. 2 and 7 further depict how server (20) is configured to communicate (180) with the forecasting services (180) and, in particular, the forecasting service data system (85). Such communication may occur via the internet or similar network.

FIG. 3 shows in greater detail Segment 300 of FIG. 1 and, in particular, the use by the user (30) of an internet gateway device (210), which may be in the form of a router or similar device with a connection to the internet, to facilitate the communication (170) between the one or more sensor devices or modules (70) and the central server (120). For example, the one or more sensor devices or modules (70) may utilise Wi-Fi, fixed wire, satellite or other connection (220) between the device or module (70) and the internet gateway device (210). By transmitting data in this way, the server (20) can effectively measure a quality attribute of water inside tank (60), and then utilise such data for the purpose of presenting useful information to the user (30) as described in greater detail below.

The one or more sensor devices or modules (70) may include internet of things (IoT) devices appropriately positioned in the vicinity of the contained water to capture data relating to the one or more quality attributes. For example, in the case of a water tank (60), the sensor device (70) may be configured to measure a level of contamination of the water stored in the tank (60). However, it is to be understood that different sensors and/or modules may be used to measure different water quality attributes, and the selection of particular sensors and/or modules will depend upon the particular application.

The sensor device (70) as shown in FIG. 3 is attached to the storage vessel (60) and captures a particular water quality attribute. Depending on the nature and location of the storage vessel, more than one sensor may be required. Typically, the sensors will be powered by one or a combination of mains power, battery or solar, and as described earlier, each sensor may be uniquely identified (72) so that the server (20) can associate a particular sensor device or module (70) with a particular user (30).

Each device or module (70) may be programmed to capture and store data (e.g. continuously or at predetermined intervals). The rate of data capture may, for example, be based upon a predetermined number of minutes or hours (e.g. the capture of sensor data may take place every 24 hours. The device (70) will then transmit the data to the server (20), as shown in FIG. 3, as soon as a connection to the server (20) is established. In the event data cannot be transferred immediately it may be stored until a connection becomes available, wherein the failure to receive timely data transmission may cause intermediate devices to be automatically activated (such as one or more drones launched automatically to travel toward the device transmission zone) to effect a data transmission from the one or more sensors.

FIG. 4 shows in greater detail Segment 400 of FIG. 1 and, in particular, a circumstance in which an internet gateway device (210) may not be available or is positioned too far from the sensor device to enable the transfer of data from the sensor device (70) to the internet gateway device (210). In this scenario, the one or more sensor devices or modules (70) may be configured to wirelessly transfer captured data indirectly to the server (20), or an associated internet gateway device (not shown in FIG. 4), via one or more intermediary devices (230, 240) operable to receive and transmit data, or at least extend or enhance the signal transmitted by the one or more sensor devices or modules (70).

FIG. 4 shows an example of a drone or similar unmanned vehicle (230) configured to fly over, or sufficiently near, the water storage tank (60) to communicate with the one or more sensor devices or modules (70) for the purpose of collecting data from the device (70) on a regular basis, and whereby the drone (230) is programmed to transmit collected data to a base station or communications tower (240) capable of receiving the data from the drone (230), and which has a connection to the internet or similar network to facilitate the transmission of such data to the server (20) or an associated device. In a farm, for example, drones or similar autonomous vehicles may be used to travel between multiple different water tanks (60) associated with the particular farm for the purpose of collecting (250) data from the one or more sensor devices or modules (70) and returning to upload (260) such data to the communications tower (240), or to the server (20) or device associated with the server (20).

FIG. 5 shows in greater detail Segment 500 of FIG. 1, and in particular, the steps associated with a user (30) (e.g. a farmer) installing (310) the software application (40) on their device, and subsequently accessing a user login and registration interface (320) associated with the application (40). Such access may be granted after the user (30) has installed the application (40) which may be achieved by downloading the application (40) from an application store. Each user (30) may create an account using the application (40) and the account information may be stored in the user account register (100).

As described above, the user account register (100) may capture information sufficient to enable each user (30) to be correctly identified.

Once the application (40) has been accessed by the user (30), the user (30) may be presented with an interface (330) that allows the user (30) to associate one or more sensor devices or modules (70) with their user account (100). For example, this may be achieved by the user (30) entering a unique sensor serial number (72) via a device keypad or by scanning a QR code on the sensor device or module (70). Additional information relating to each sensor may be captured in this process, including the GPS co-ordinates of the sensor and the particular water quality attributes that the sensor is capable of capturing with respect to the contained volume of water (60).

FIG. 6 shows in greater detail elements of Segment 600 of FIG. 1 and, in particular, use of the software application (40) by the user (30) to view, in an interface (340), the captured one or more water quality attributes associated with the contained volume of water (60), and the prediction regarding how the one or more attributes are likely to change over a period of time, thereby enabling the user to receive, substantially in real-time, an indication of the one or more attributes and the prediction.

In one example, the forecast data received from the forecasting servers (80) (e.g. Bureau of Meteorology, or Amazon forecast application programming interface (API)) relates to future environmental conditions including forecasted temperature, wind, fire (e.g. from bushfires), ultraviolet (UV) radiation, and rain (precipitation) at the particular location (74), or in the geographical region associated with the location (74), as well as data relating to how such conditions are likely to change over a period of time (e.g. over the course of a day, night, 24-hour period, week, month etc.). Such data may then be processed using the intelligent predictive analysis functionality (150) to generate useful predictions regarding how the water quality, and in particular individual water quality attributes, are expected to change over time.

For example, where a significant downpour is forecast in a geographical region in which a waterway is located, and there is a chance of flooding (an example of a blackwater event), then such an event may be identified as likely to give rise to increased organic matter in the waterway, which can have the effect of increasing dissolved carbon in the water. Accordingly, by capturing such forecast data, a prediction can be made in relation to an attribute of water quality (i.e. carbon content in the water) and how that attribute is expected to change in the future. Similarly, if the forecast data indicates that a particular waterway is likely to be affected by a nearby bushfire, i.e. increased risk of sediments and pollutants, then again it can be predicted that an attribute of water quality (i.e. level of sediment and pollutants in the water) will be adversely affected.

In an example involving a water tank holding still water, levels of bacteria in the tank (e.g. algae) may increase when there is an abundance of sunlight for example. Accordingly, if the forecast data indicates multiple days or weeks of sunlight, then it can be predicted that an attribute of water quality (e.g. a level of bacteria) will be adversely affected. On the other hand, if rain is forecast, this may have a positive effect upon the quality of water stored in the tank, since the additional rain may serve to dilute the concentration of contaminants.

As mentioned previously, the data received may further include historical data previously captured from the one or more sensor devices or modules. By utilising historical data, trends in the data may be determined (using trend analysis techniques) with respect to particular events that trigger water quality changes and such trend analysis data may be used in isolation, or in combination with the forecast data, when determining predictions regarding how the one or more attributes of water quality are likely to change over a period of time. For example, if the trend analysis indicates that water quality was adversely affected following a particular weather pattern, such data may be processed together with forecast data which predicts when such a weather pattern is likely to occur again, to generate an accurate prediction regarding when the particular adverse effect is likely to occur again.

By being automatically advised of such changes to water quality before the change occurs, users (30) are much better equipped to not only treat the water quality issue, but they may attend to same in a manner that is far more efficient and which utilises reduced amounts of computer processing, memory and network resources.

Accordingly, where the sensor device (70) captures one or more attributes of water quality, it will be appreciated that the interface (340), subsequent to processing such data by the intelligent predictive analysis functionality (150), may provide a real-time indication of the one or more attributes. This may include an indication of water quality (e.g. real-time values associated with each detected attribute, including a current level of contaminants, salinity, acidity, bacteria, etc). The display of the real-time indication of the one or more water quality attributes may also provide a comparison with a pre-defined value (e.g. the level of pollutants as compared with a predefined safety threshold for such pollutants). Additional displayed attributes may include one or more current and/or future conditions in the geographical region that may affect the water quality (e.g. a current and/or future UV or precipitation forecast) and/or a display of a period of time (e.g. day, week, month) and how the one or more attributes of water quality are likely to change over the period of time.

Such information may be overlaid onto one or more tables or graphs, such as the examples depicted in interface (340) in FIG. 6. For example, a graph may include one axis relating to time, and another axis relating to the captured one or more attributes of water quality (e.g. a graph of pollutant level, algae level, acidity, salinity, etc, versus time).

The interface (340) may also include filters to enable the user (30) to filter the results to focus on particular results. For example, the user (30) may select to view how the water quality in a particular tank is predicted to change over the next 24 hours, the next two days, the next seven days, or over the next month, etc. The interface (340) may further depict the one or more attributes of water quality in a graphical representation that represents the appearance of the physical attribute (e.g. a 2-D, or 3-D depiction of a tank (60) or waterway) with a representation of the attributes of water quality, such as pollutants, sediment, salinity, etc, in the tank at the particular instance in time, and at any particular future point in time.

FIG. 6 further illustrates an alerts/notification interface (350) for issuing alerts/notifications to users (30). For example, when the server (20) and processors capture data and determine that one or more attributes of water quality no longer satisfy a minimum threshold (e.g. where a particular contaminant value exceeds a maximum safety threshold), the user (30) may be notified regarding same. The information provided in interface (340) and the alert notifications provided by interface (350) assist the user (30) to understand the water quality inside the water tank (60) and thereby enables the user (30) to take appropriate action, including scheduling an appropriate action in the future, and to generally assist the user (30) with respect to their water quality management.

In another embodiment, the server (20) may cause one or more actions to be performed to address a particular water quality attribute being detected as failing to satisfy a particular threshold, or likely to fail to satisfy a particular threshold in the future. For example, a pump (not shown) associated with tank (60) which is operable to pump water into the tank (60) when required, may be caused to operate when a quantity of contaminants are detected in the water as being above a predefined safety threshold. By pumping more water into the tank, the contaminants present in the water may be diluted and returned to a quantity that satisfies the safety threshold (e.g. sufficiently free of contaminants to enable the water to be used again).

The interface (350) may also provide alerts and/or notifications with respect to faults (e.g. when it is detected that data is no longer transmitted by one or more sensor devices (70)), and the software application (40) may be used to troubleshoot the faults and enable the user (30) to take appropriate corrective action, or the application (40) may cause corrective action to occur automatically without the requirement for input from the user (30).

It will be appreciated that by providing the user (30) with a forecast regarding how the quality of water in the contained vessel is likely to behave over a future period of time, the user (30) can more easily manage their water storage and reduce instances of water reaching a quality that is potentially unsafe (e.g. for use in irrigation, consumption, etc). Users (30) can establish alerts such that they are notified of particular events (e.g. when a particular contamination level has been reached). Such alerts and notifications can be sent to the user (30) in one or more of the interfaces generated by the software application (40), by push notification, text message or email.

The software application (40) may also enable the user (30) to provide user feedback data regarding the success, or otherwise, of different water quality management strategies with respect to management of the contained waster (60) (e.g. where a particular type of tank or tank liner gave rise to a decreased contamination and lasted longer than another type of tank/liner, whether causing a tank to be exposed to sunlight or covered results in additional water quality benefits, whether causing a tank to be re-filled at a particular time in the year or to be located in a particular geographical region results in additional water quality benefits as compared with alternative times of year/regions, whether using one water treatment method (e.g. filtration, chlorination, dilution, UV, etc) as compared with other methods results in additional water quality benefits, etc).

In this regard, the server (20) may store the data captured by the one or more sensor devices or modules (70) as well as the forecasted data from the one or more third party services (80), and any feedback data from the user (30), to develop a database of useful data for subsequent analysis. For example, a machine learning model may be trained utilising such data to generate recommendations regarding future water quality management strategies with respect to the contained volume of water (60). The machine learning model may be trained over time using such data, and therefore over time, the recommendations provided by the model will become more accurate and thereby more helpful to the user (30).

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (eg. software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. A computer-implemented method for remotely monitoring the quality of a contained volume of water, the method comprising:
receiving, by one or more processors, data from one or more sensor devices or modules operable to monitor one or more attributes of water quality associated with the contained volume of water;
receiving, by one or more processors, data from one or more third party services that provide forecast data relating to environmental conditions at a geographical region in which the contained volume of water is located, the environmental conditions of a type that have an effect upon the one or more water quality attributes;
generating, by one or more processors, based upon the data from the one or more sensor devices or modules, and the forecast data received from the one or more third party services, a prediction regarding how the one or more attributes of water quality are likely to change over a period of time; and
processing, by one or more processors, the data from the one or more sensor devices or modules, the forecast data received from the one or more third party services, and the generated prediction, to generate a graphical user interface (GUI) comprising one or more user interface objects adapted to be displayed on a data communication device associated with a user,
wherein the one or more attributes of water quality, and the prediction relating to how the one or more attributes of water quality are likely to change over a period of time, are overlaid on the one or more user interface objects, thereby assisting the user to identify, substantially in real-time, an indication of the one or more attributes of water quality and the prediction regarding variation of same into the future.

2. The method of claim 1, wherein the contained volume of water is associated with one or more of:
a tank,
a trap,
a river,
a dam, or
a reservoir.

3. The method of claim 1, wherein the one or more third party services that provide forecast data comprise a third party service capable of providing weather forecasting data, wherein the forecasting data relates to future environmental conditions comprising forecasted temperature, wind and/or rain in the geographical region.

4. The method of claim 3, further comprising providing data obtained from the one or more sensor devices or modules to the one or more third party services.

5. The method pf claim 1, wherein the one or more sensor devices or modules comprises an Internet of Things (IoT) device appropriately positioned in, or adjacent, the contained water to capture data relating to the one or more attributes of water quality.

6. The method of claim 5, wherein the contained water is associated with a water tank, and the one or more sensor devices are affixed to an internal wall of the tank in order to measure water quality attributes.

7. The method of claim 5, wherein each sensor device or module has a battery source operable to be charged by solar power.

8. The method of claim 5, wherein the one or more processors are associated with a central server and the one or more sensor devices or modules are configured to wirelessly transmit captured data directly to the central server, or indirectly to the central server via one or more intermediate devices, wherein the one or more intermediate devices comprise one or more of:
a modem;
a terrestrial transponder, or
a satellite transponder.

9. (canceled)

10. (canceled)

11. The method of claim 8, wherein the intermediate device is mounted to an autonomous vehicle capable of travelling between a first location adjacent the one or more sensor devices or modules and a second location adjacent the central server.

12. The method of claim 1, wherein the one or more user interface objects comprises one or more of:
a digital display of the real-time indication of the one or more attributes of water quality,
a digital display of the real-time indication of the one or more attributes of water quality as compared with a predefined value for the one or more attributes,
a digital display of one or more current and/or future environmental conditions in the geographical region,
a digital display of a period of time and an estimation regarding how the one or more attributes of water quality are likely to change over a period of time, or
a digital display of one or more graphs of which one axis represents time, and another axis relates to the one or more attributes of water quality.

13. The method of claim 1, wherein the period of time displayed in the digital display is selectable by a user.

14. The method of claim 1, wherein the one or more attributes of water quality are displayed in a two-dimensional or three-dimensional graphical representation that represents the actual appearance of the one or more attributes of water quality.

15. The method of claim 14, wherein the volume of water is associated with a tank, and the graphical representation is in the form of a two-dimensional or three-dimensional graphical image of the tank comprising a graphical indication of a level of contaminants detected in the actual volume of water in the tank.

16. The method of claim 1, further comprising causing one or more actions to be performed when the one or more attributes of water quality are detected as failing to satisfy a predefined requirement or threshold, wherein the one or more actions comprise one or more of:
generating a notification or alert and transmitting same to a user by one or more of overlaying the notification or alert on a graphical user interface object displayed in the GUI, or alternatively and/or additionally, a push notification, text message or email to a user device, and
operating one or more devices associated with the contained volume of water, the device configured to improve the one or more attributes of water quality.

17. The method of claim 16, wherein the contained volume of water is associated with a tank, and the one or more devices comprise a pump associated with the tank, the pump configured to automatically provide additional water to the tank when a quantity of contaminants in the water are detected as exceeding, or are predicted to exceed, a predefined safety threshold.

18. The method of claim 1, further comprising:
receiving, by one or more processors, user feedback data regarding the success or otherwise of different strategies with respect to managing water quality associated with the contained volume of water.

19. The method of claim 18, further comprising:
storing, in one or more databases, data captured by the one or more sensor devices or modules, the data from the one or more third party services, and any feedback data, thereby enabling development of a database of data for training a machine learning model.

20. The method of claim 19, further comprising:
generating, using the trained machine learning model, recommendations regarding future water quality management strategies with respect to the contained volume of water, the machine learning model trained over time using the stored data including comprising feedback data relating to the success or otherwise associated with different management strategies.

21. A system for remotely monitoring the quality of a contained volume of water, the system comprising:
one or more processors operable to:
receive data from one or more sensor devices or modules operable to monitor one or more attributes of water quality associated with the contained volume of water;
receive data from one or more third party services that provide forecast data relating to environmental conditions at a geographical region in which the contained volume of water is located, the environmental conditions of a type that have an effect upon the one or more water quality attributes;
generate, based upon the data from the one or more sensor devices or modules, and the forecast data received from the one or more third party services, a prediction regarding how the one or more attributes of water quality are likely to change over a period of time; and
process the data from the one or more sensor devices or modules, the forecast data received from the one or more third party services, and the generated prediction, to generate a graphical user interface (GUI) comprising one or more user interface objects adapted to be displayed on a data communication device associated with a user,
wherein the one or more attributes of water quality, and the prediction relating to how the one or more attributes of water quality are likely to change over a period of time, are overlaid on the one or more user interface objects, thereby assisting the user to identify, substantially in real-time, an indication of the one or more attributes of water quality and the prediction regarding variation of same into the future.

22. A non-transitory computer-readable medium having a plurality of instructions executable by one or more processors configured to:
receive data from one or more sensor devices or modules operable to monitor one or more attributes of water quality associated with the contained volume of water;
receive data from one or more third party services that provide forecast data relating to environmental conditions at a geographical region in which the contained volume of water is located, the environmental conditions of a type that have an effect upon the one or more water quality attributes;
generate, based upon the data from the one or more sensor devices or modules, and the forecast data received from the one or more third party services, a prediction regarding how the one or more attributes of water quality are likely to change over a period of time; and
process the data from the one or more sensor devices or modules, the forecast data received from the one or more third party services, and the generated prediction, to generate a graphical user interface (GUI) comprising one or more user interface objects adapted to be displayed on a data communication device associated with a user,
wherein the one or more attributes of water quality, and the prediction relating to how the one or more attributes of water quality are likely to change over a period of time, are overlaid on the one or more user interface objects, thereby assisting the user to identify, substantially in real-time, an indication of the one or more attributes of water quality and the prediction regarding variation of same into the future.
